(19) United States
(12) Patent Application Publication
(10) Pub. No.: US 2019/0040951 A1
(43) Pub. Date: Feb. 7, 2019

(54) METHOD FOR SLIP AVOIDANCE IN A BALL PLANETARY TYPE CONTINUOUSLY VARIABLE TRANSMISSION

(71) Applicant: DANA LIMITED, MAUMEE, OH (US)

(72) Inventors: JEFFREY M. DAVID, CEDAR PARK, TX (US); GORDON M. MCINDOE, VOLENTE, TX (US); THOMAS NEIL MCLEMORE, GEORGETOWN, TX (US); PATRICK SEXTON, AUSTIN, TX (US); MATTHEW SIMISTER, AUSTIN, TX (US); ROBERT A. SMITHSON, LEANDER, TX (US)

(73) Assignee: DANA LIMITED, MAUMEE, OH (US)

(21) Appl. No.: 16/072,598

(22) PCT Filed: Jan. 26, 2017
(86) PCT No.: PCT/US2017/015037

§ 371 Date: Jul. 25, 2018

Related U.S. Application Data
(60) Provisional application No. 62/287,309, filed on Jan. 26, 2016.

(51) Int. Cl. F16H 61/664; F16H 15/50

(52) U.S. Cl. CPC F16H 61/6649; F16H 2059/147; F16H 15/503

(57) ABSTRACT

Provided herein is a control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The system also has a dither control module configured to store at least one calibration map, and configured to determine an oscillating change in speed ratio applied to a commanded speed ratio signal during operation of the CVP to manage thermal and mechanical stress on the surface of the ball.

### RELATED APPLICATION

This application claims the benefit of U.S. Provisional Application No. 62/287,309 filed on Jan. 26, 2016, which is herein incorporated by reference.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that could be implemented in a CVT are not be sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations could, for example, multiply input torque across the different transmission stages in different manners to achieve the same final drive ratio. However, some configurations provide more flexibility or better efficiency than other configurations providing the same final drive ratio.

The criteria for optimizing transmission control could be different for different applications of the same transmission. For example, the criteria for optimizing control of a transmission for fuel efficiency will differ based on the type of prime mover applying input torque to the transmission. Furthermore, for a given transmission and prime mover pair, the criteria for optimizing control of the transmission will differ depending on whether fuel efficiency or performance is being optimized.

### SUMMARY

Provided herein is a computer-implemented system for a vehicle having an engine coupled to a continuously variable transmission having a ball-planetary variator (CVP) including a digital processing device having an operating system configured to perform executable instructions and a memory device; a computer program including instructions executable by the digital processing device including a software module configured to manage operating conditions of the CVP; a plurality of data signal including: a CVP speed ratio, an input traction ring torque and an engine speed, wherein the software module is configured to execute a dither control sub-module, wherein the dither control sub-module includes a look-up table configured to store values of a contact patch size based at least in part on the CVP input torque.

Provided herein is a method for preventing slip in a to a continuously variable transmission having a ball-planetary variator (CVP), the method including the steps of: operating a continuously variable planetary having a plurality of tiltable balls in contact with a first traction ring assembly and a second traction ring assembly wherein a speed ratio between the first traction ring assembly and the second traction ring assembly corresponds to a title angle of the balls; receiving a plurality of signals from sensors equipped on the CVP, the signals indicative of a CVP speed ratio, a CVP input traction ring torque, and an engine speed; determining a contact patch size, wherein the contact patch is formed between contacting components of the CVP; determining a contact patch location, wherein the contact patch location is based at least in part on the dimensions of the CVP and the CVP speed ratio; and determining a dither magnitude signal based at least in part on the plurality of signals, the dither magnitude signal based at least in part on the contact patch size and the contact patch location.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that could be used in the variator of FIG. 1.

FIG. 3 is an illustrative view of different tilt positions of the ball-type variator of FIG. 1.

FIG. 4 is an illustrative view of different geometric parameters of the ball-type variator of FIG. 1.

FIG. 5 is an illustrative view of stresses in a contact patch location.

FIG. 6 is a graph representing the relationship between contact patch size and operating torque.

FIG. 7 is a block diagram schematic of a transmission control system that could be implemented in a vehicle.

FIG. 8 is a block diagram of a dither magnitude process that is implemented in the transmission control system of FIG. 7.

FIG. 9 is a block diagram of a dither command generator process that is implemented in the transmission control system of FIG. 7.

FIG. 10 is a block diagram schematic of a dither control sub-module that is implemented in the transmission control system of FIG. 7.

FIG. 11 is a block diagram schematic of a dither magnitude sub-module that is implemented in the dither control sub-module of FIG. 10.

FIG. 12 is a block diagram schematic of a dither command generator sub-module that is implemented in the dither control sub-module of FIG. 10.

FIG. 13 is a block diagram schematic of a dither activation sub-module that is implemented in the dither command generator sub-module of FIG. 12.

FIG. 14 is a block diagram schematic of a dither profile sub-module that is implemented in the dither command generator sub-module of FIG. 12.

FIG. 15 is a block diagram schematic of a dither profile selector sub-module that is implemented in the dither command generator sub-module of FIG. 12.

FIG. 16 is a block diagram schematic of a dither enable process that is implementable in the dither control sub-module of FIG. 10.

FIG. 17 is a block diagram schematic of the dither enable process of FIG. 16.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller could be configured to receive input signals indicative of parameters associated with an engine coupled to the transmission. The parameters could include throttle position sensor values, accelerator pedal position sensor values, vehicle speed, gear selector position, user-selectable mode configurations, and the like, or some combination thereof. The electronic controller could also receive one or more control inputs. The electronic controller could determine an active range and an active variator mode based on the input signals and control inputs. The electronic controller could control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. Patent Application No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but could be configured to control any of several types of variable ratio transmissions. In the embodiments described herein, the electronic controller is configured to implement a number of control sub-modules to control the operating condition of a ball planetary-type continuously variable transmission. In some embodiments, the electronic controller is configured to avoid slip in the ball planetary-type continuously variable transmission by implementing a high frequency, low magnitude, oscillating speed ratio command, sometimes referred to herein as dither.

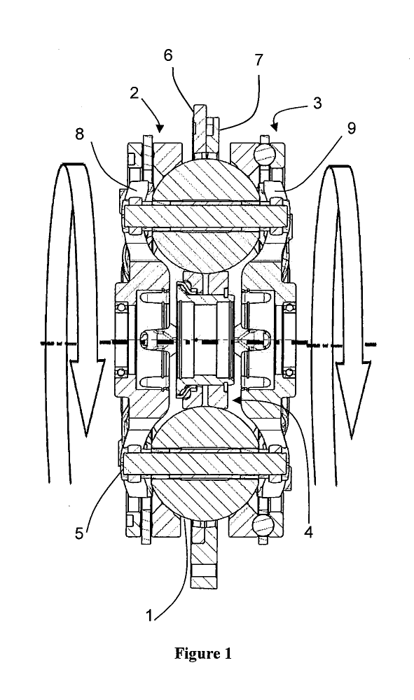

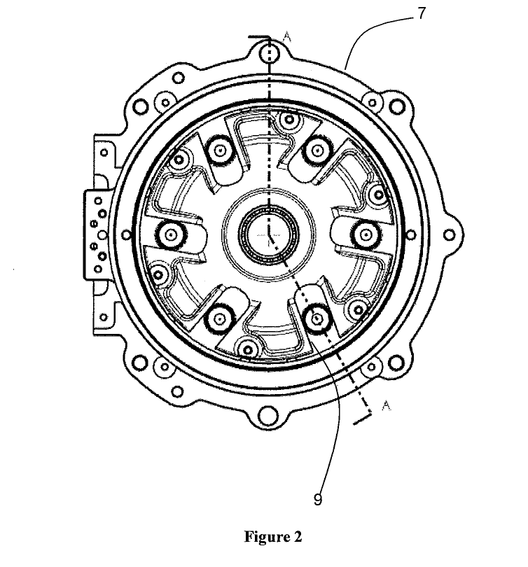

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input traction ring 2 and output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

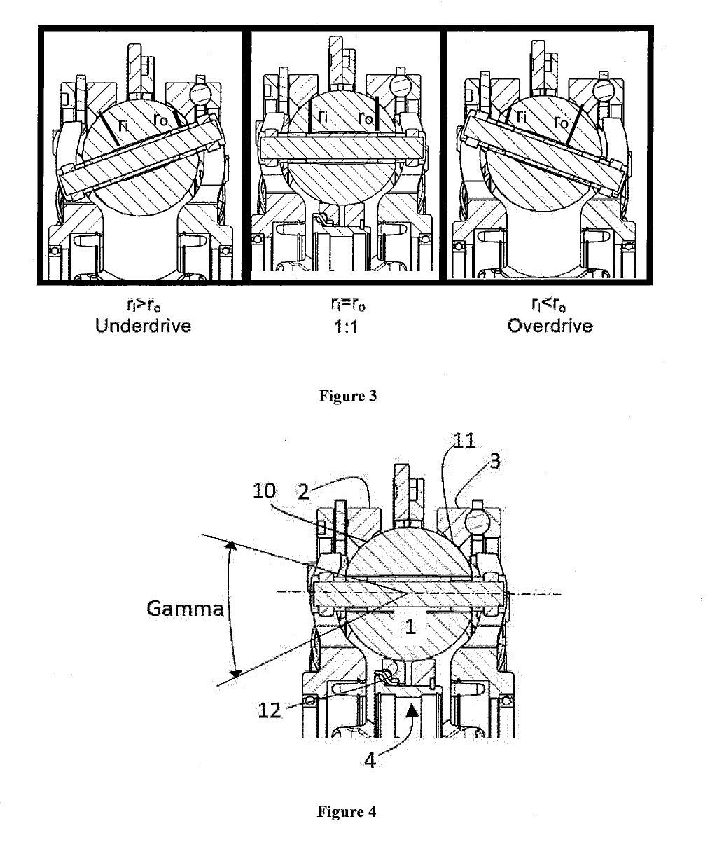

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. As used herein, the term “gamma angle” refers to the position of the tilting ball with respect to a longitudinal axis of the CVP. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

Turning to FIGS. 4-6, and still referring to FIGS. 1-3, the input traction ring 2 is in contact with the surface of the ball 1 at a first contact patch 10. The output traction ring 3 is in contact with the ball 1 at a second contact patch 11. The idler assembly 4 is in contact with the surface of the ball 1 at a third contact patch 12. In some embodiments, the idler assembly 4 has two contacting components with the ball surface and thereby has two contact patches. For description purposes, the first contact patch 10 will be used as an illustrative representation of a typical contact patch location on the surface of the ball 1. The tilt angle of the axis of the ball 1 is geometrically defined by the angle labeled “gamma” in FIG. 4, and referred to herein as “gamma angle range”.

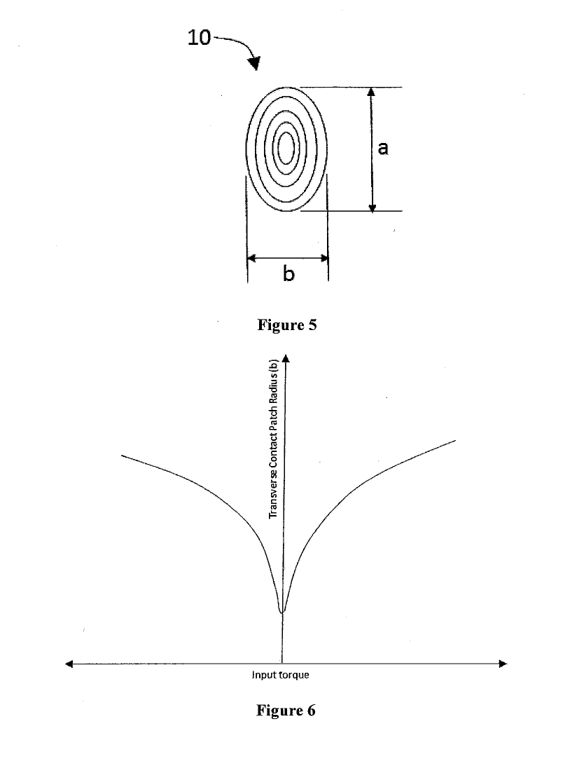

The gamma angle is a design parameter typically set by a designer based on the size of the balls and the traction rings and other geometric and operating considerations. During operation of the CVP, a change in the speed ratio corresponds to a change in position of the first contact patch 10 on the surface of the ball 1. Forces generated during operation of the CVP create Hertzian contact stress in the first contact patch 10. Referring specifically to FIG. 5, Hertzian contact stress between contacting components is typically illustrated by concentric elliptical lines representing constant magnitudes of stress in the contact region. The contact region is an area of both high mechanical stress and high thermal stress. The length labeled “a” in the figure corresponds to the radius of the elliptical line in the rolling direction of the contact. The length labeled “b” in the figure corresponds to the elliptical radius in the transverse or longitudinal direction with respect to the ball. Referring specifically to FIG. 6, the size of the contact patch is dependent on the operating torque of the CVP and is illustrated by a graph of input torque versus transverse contact patch radius “b”. As will be described herein, a control system is configured to adjust the location of the first contact patch 10 in a high frequency manner so as to be substantially imperceptible to an operator of a vehicle. As used here, the term “dither” refers to a high frequency, low amplitude, oscillating change in speed ratio applied to a commanded speed ratio signal during operation of the CVP to manage thermal and mechanical stress on the surface of the ball 1. In some embodiments, dither optionally is configured as a low frequency, low amplitude, oscillating change in speed ratio applied to a commanded speed ratio signal during operation of the CVP to manage thermal and mechanical stress on the surface of the ball 1.

For description purposes, the term “dither magnitude” is used here to indicate the size or amplitude of the high frequency, low amplitude, oscillating change in speed ratio. In some embodiments, the dither magnitude is expressed having units of speed ratio. In some embodiments, the dither magnitude is expressed having units corresponding to contact patch size or some fraction of the contact patch size.

For description purposes, the term “dither profile” is used here to describe characteristics of the oscillation of the high frequency, low amplitude change in speed ratio. For example, the dither profile has a sinusoidal profile, indicating that the dither magnitude is applied to the commanded speed ratio in a sinusoidal frequency pattern. In some embodiments, the dither profile is a stepped profile oscillating from a negative dither magnitude to a positive dither magnitude at a prescribed frequency.

For description purposes, the term “torque threshold” is used here to indicate a calibrateable value of torque at which a designer desires a control sub-module to enable operation or dis-able operation.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 10118) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (p) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source could be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the preferred embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the IVT comprises a processor (not shown).

In some embodiments, the control system for a vehicle equipped with a CVT disclosed herein includes at least one computer program, or use of the same. A computer program includes a sequence of instructions, executable in the digital processing device's CPU, written to perform a specified task. Computer readable instructions are optionally implemented as program modules, such as functions, objects, Application Programming Interfaces (APIs), data structures, and the like, that perform particular tasks or implement particular abstract data types. In light of the disclosure provided herein, those of skill in the art will recognize that a computer program is optionally written in various versions of various languages.

The functionality of the computer readable instructions are optionally combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

As used here, the terms “table”, “look-up table”, or “map” refer to an array of indexed values stored in memory containing output values associated with each input value.

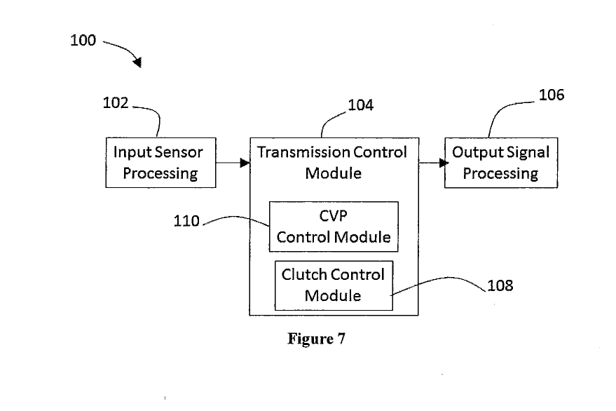

Referring now to FIG. 7, in one embodiment, a transmission controller 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. One sub-module included in the CVP control sub-module 110 is described herein.

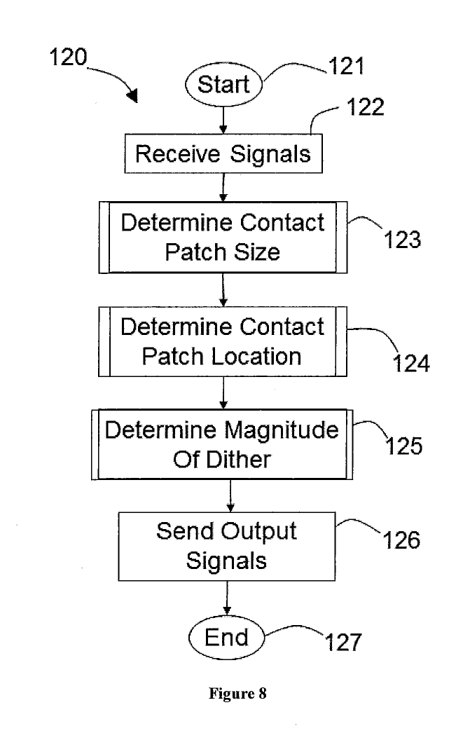

Referring now to FIG. 8, in one embodiment, a dither magnitude process 120 is implemented in the CVP sub-module 110. The dither magnitude process 120 begins at a start state 121 and proceeds to a block 122 where a number of input signals are received. For example, signals indicative of speed ratio, engine torque, and engine speed, among others are received from other sub-modules of the transmission control module 104. In some embodiments, the input signals optionally include a signal indicative of a fluid temperature, a signal indicative of a fluid estimated life estimation, a signal indicative of a cumulative operating time at a particular speed ratio, and signal indicative of a contact patch temperature. In some embodiments, the contact patch temperature is either measured with a sensor or estimated from a computational model executable in the transmission control module 104. The dither magnitude process 120 proceeds to a block 123 where the contact patch size is determined based at least in part on the signals received in the block 122. In some embodiments, the contact patch size is determined by a sub-process (not shown) that optionally includes uses input signals indicative of axial force on the traction rings, physical dimensions of CVP components configured to generate the axial on the traction rings, among other parameters. The dither magnitude process 120 proceeds to a block 124 where the contact patch location is determined based at least in part on the signals received in the block 122. The dither magnitude process 120 proceeds to a block 125 where a magnitude for dither is determined based at least in part on the size of the contact patch and the location of the contact patch. In some embodiments, the dither magnitude is a speed ratio range corresponding to the width of the contact patch. In some embodiments, the dither magnitude is a speed ratio range corresponding to a fraction of the width of the contact patch where the fraction is a calibrateable value. In some embodiments, the dither magnitude is greater than the width of the contact patch to move the contact patch location on the surface of the ball to a location out of a thermally overloaded location on the surface of the ball. The dither magnitude process 120 proceeds to a block 126 where signals are passed to other sub-modules in the transmission control module 104. The dither magnitude process 120 ends at a state 127.

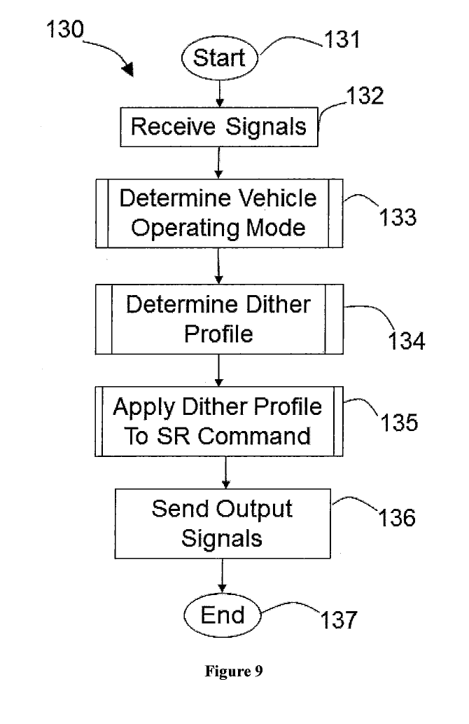

Turning now to FIG. 9, in one embodiment, a dither command generator process 130 in implemented in the CVP sub-module 110. The dither command generator process 130 begins at a start state 131 and proceeds to a block 132 where a number of input signals are received. For example, signals indicative of dither magnitude, current speed ratio, engine torque, and engine speed, among others are received from other sub-modules of the transmission control module 104. The dither command generator process 130 proceeds to a block 133 where a current vehicle operating mode is determined based at least in part on the input signals received in the block 132. The dither command generator process 130 proceeds to a block 134 wherein a desired dither profile is determined based at least in part on the vehicle operating mode determined in the block 133 and the input signals received in the block 132. The dither command generator process 130 proceeds to a block 135 where the dither profile determined in the block 134 is applied to a commanded speed ratio signal. In some embodiments, the commanded speed ratio signal is formed in another sub-module of the CVP sub-module 110. The dither command generator process 130 proceeds to a block 136 where an output signal based at least in part on the results of the block 135 is passed as an output signal to other sub-modules in the transmission control module 104. The dither command generator process 130 ends at an end state 137.

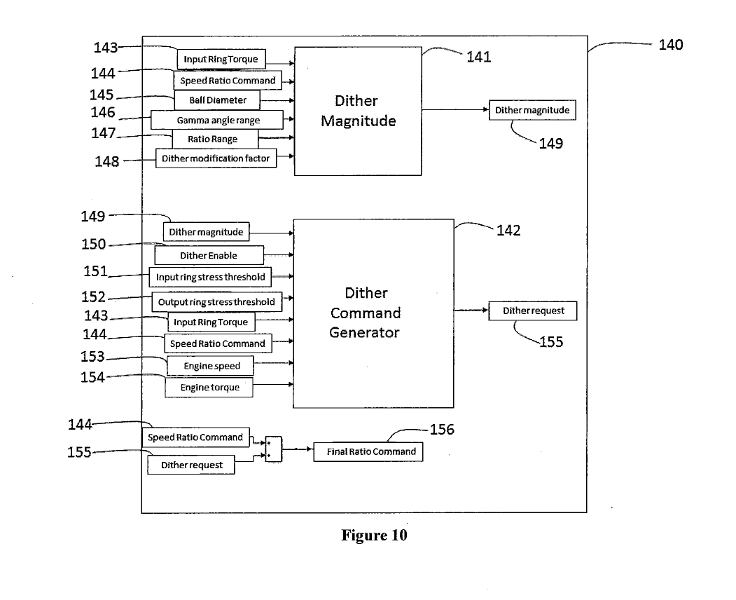

Referring now to FIG. 10, in one embodiment, a dither control sub-module 140 is implemented in the CVP sub-module 110. The dither control sub-module 140 includes a dither magnitude sub-module 141 and a dither command generator sub-module 142. The dither magnitude sub-module 141 is adapted to receive a number of input signals such as an input traction ring torque signal 143 and a commanded speed ratio signal 144. In some embodiments, the input traction ring torque signal 143 is indicative of a torque transmitted at the input traction ring 2, for example. In some embodiments, the commanded speed ratio signal 144 is determined in another sub-module of the CVP sub-module 110. The dither magnitude sub-module 141 is adapted to receive a number of signals from calibration variables configured to be read from memory. The calibration variables are indicative of particular dimensions and geometry of the CVP. For example, the dither magnitude sub-module 141 receives a ball diameter calibration variable 145, a gamma angle calibration variable 146, a ratio range calibration variable 147, and a dither modification factor calibration variable 148. The dither magnitude sub-module 141 executes algorithms to determine a dither magnitude signal 149 based at least in part on the input signals.

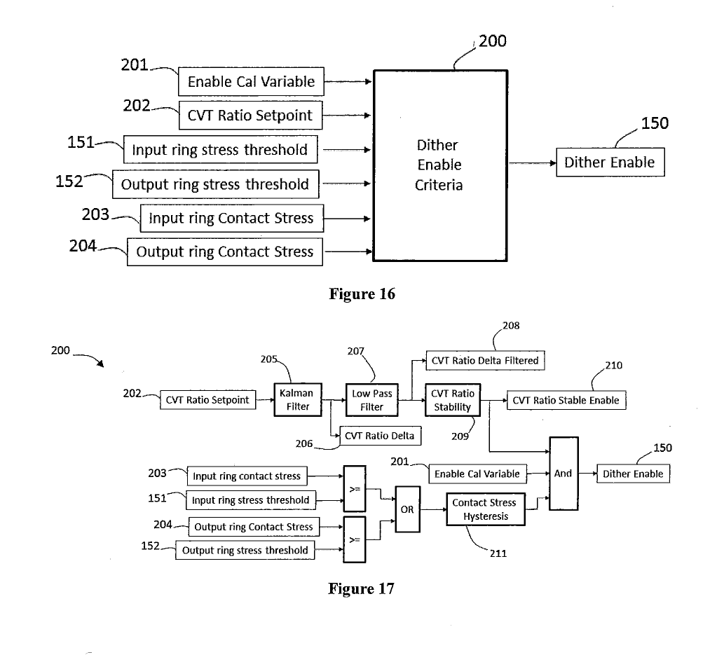

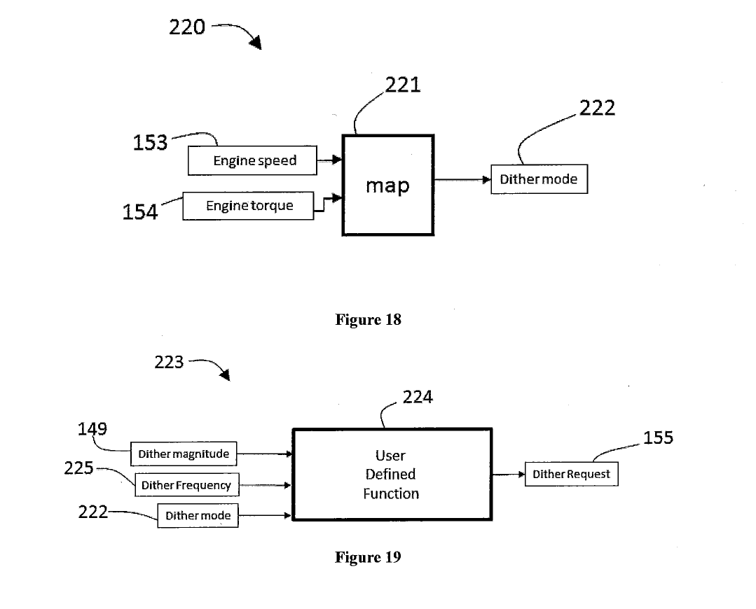

In one embodiment, the dither command generator sub-module 142 is configured to receive the dither magnitude signal 149 determined in the dither magnitude sub-module 141. The dither command generator sub-module 142 is configured to receive a number of calibration variables that are read from memory. In some embodiments, the dither command generator sub-module 142 receives a dither enable variable 150. The dither enable variable 150 indicates if the dither control methods executed by the dither control sub-module 140 are enabled for transmissions equipped with the transmission control module 104. In some embodiments, the dither enable variable 150 is determined in a dither enable criteria sub-module 200, discussed in reference to FIGS. 16 and 17. In some embodiments, the dither command generator sub-module 142 receives an input traction ring stress threshold calibration variable 151 and an output traction ring stress threshold calibration variable 152. In some embodiments, an input traction ring torque threshold and an output traction ring torque threshold are optionally used. The input traction ring stress threshold calibration variable 151 and the output traction ring stress threshold calibration variable 152 are indicative of the minimum contact stress to enable the dither control sub-module 140. The dither command sub-module 142 is configured to receive a number of input signals from other sub-modules implemented in the transmission control module 104. In some embodiments, the dither command generator sub-module 142 receives the input traction ring torque signal 143, which is indicative of a torque transmitted at the input traction ring 2, for example. In some embodiments, the dither command generator sub-module 142 receives the commanded speed ratio signal 144, which is determined in another sub-module of the CVP sub-module 110. In some embodiments, the dither command generator sub-module 142 receives an engine speed signal 153 and an engine torque signal 154. The dither command generator sub-module 142 determines a dither request signal 155 based at least in part on the input signals. The dither request signal 155 is applied to the commanded speed ratio signal 144 to form a final ratio command signal 156.

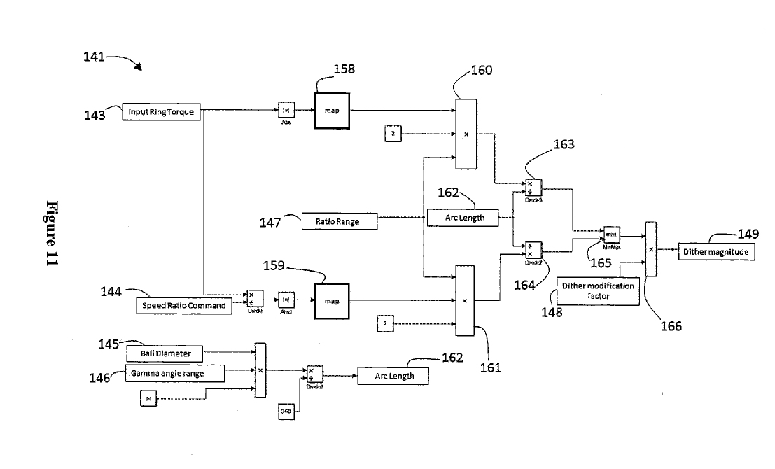

Referring now to FIG. 11, in one embodiment, the dither magnitude sub-module 141 includes a first look-up table 158. The first look-up table 158 is read from memory and contains calibration values for the transverse contact patch radius “b” (FIG. 5) based at least upon the input traction ring torque signal 143. In some embodiments, the first look-up table 158 is optionally replaced with an online calculation of the transverse contact patch radius “b”. In some embodiments, the output traction ring torque is determined by dividing the input traction ring torque signal 143 by the commanded speed ratio signal 144. The dither magnitude sub-module 141 includes a second look-up table 159. The second look-up table 159 is read from memory and contains calibration values for the transverse contact path radius “b” based at least in part on the output ring torque signal. The first look-up table 158 is configured to pass a signal to a first multiplication block 160 where the signal is multiplied by the constant value “2” and the ratio range calibration variable 147. The second look-up table 159 is configured to pass a signal to a second multiplication block 161 where the signal is multiplied by the constant value “2” and the ratio range calibration variable 147. In some embodiments, the dither magnitude sub-module 141 determines an arc length signal 162 based at least in part on the ball diameter calibration variable 145 and the gamma angle calibration variable 146. The first multiplication block 160 passes a signal to a first division block 163 where the signal is divided by the arc length signal 162. The second multiplication block 161 passes a signal to a second division block 164 where the signal is divided by the arc length signal 162. The first division block 163 and the second division block 164 pass signals to a comparison block 165. The comparison block 165 passes the greater of the two signals received to a third multiplication block 166 where the dither modification factor calibration variable 148 is multiplied to determine the dither magnitude signal 149. In some embodiments, the dither modification factor calibration variable 148 allows for a calibrateable amount of movement between zero and one to tune the amount of contact patch movement. For example, a value of one for the dither modification factor calibration variable 148 corresponds to a commanded dither magnitude that moves the contact patch completely outside of the current calculated contact patch region. Under certain operating conditions, the dither magnitude is tuned to move within the calculated current contact patch region by utilizing a dither modification factor calibration value less than 1.

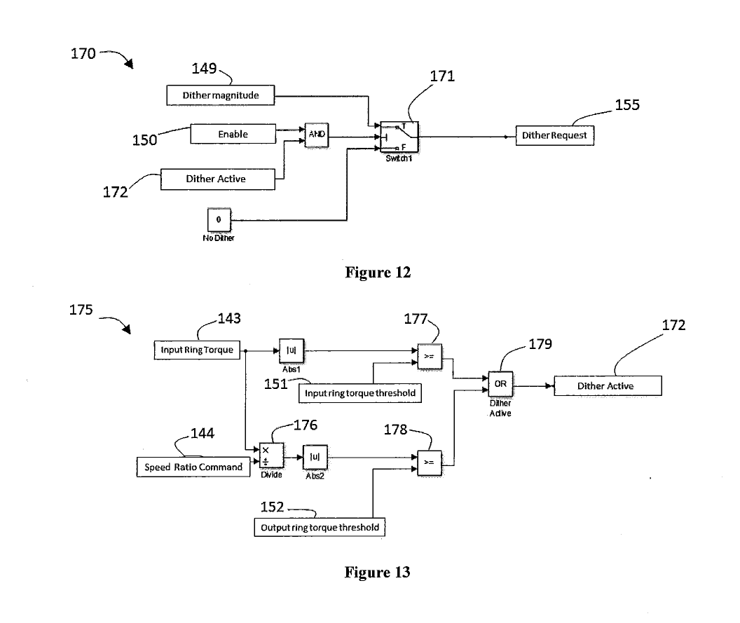

Turning now to FIG. 12, in one embodiment, the dither command generator sub-module 142 is configured to include an enable sub-module 170. The enable sub-module 170 receives a dither request signal 193 as an input signal. The enable sub-module 170 is provided with a switch block 171. The switch block 171 is configured to select between the dither magnitude signal 149 and a constant value of zero based on the comparison of the dither enable variable 150 and a dither active signal 172. The switch block 171 determines the dither request signal 155.

Referring now to FIG. 13, in one embodiment, the dither command generator sub-module 142 is configured to include a dither activation sub-module 175. The dither activation sub-module 175 is configured to determine the dither active signal 172 based at least in part on the input traction ring torque signal 143, the commanded speed ratio signal 144, the input traction ring stress threshold calibration variable 151 and the output traction ring stress threshold calibration variable 152. In some embodiments, a division block 176 is configured to divide the input traction ring torque signal 143 by the commanded speed ratio signal 144 to determine the output traction ring torque signal. The dither activation sub-module 175 includes a first comparison block 177 configured to compare the input traction ring torque signal 143 to the input traction ring stress threshold calibration variable 151. The first comparison block 177 passes a true signal if the input traction ring torque signal 143 is greater than or equal to the input traction ring stress threshold calibration variable 151. The dither activation sub-module 175 includes a second comparison block 178 configured to compare the output traction ring torque signal determined by the division block 176 to the output traction ring stress threshold calibration variable 152. The second comparison block 178 passes a true signal if the output traction ring torque signal is greater than or equal to the output traction ring stress threshold calibration variable 152. The dither activation sub-module 175 includes a Boolean block 179 that is configured to receive the signals formed in the first comparison block 177 and the second comparison block 178. The Boolean block 179 passes a true value if either the first comparison block 177 or the second comparison block 178 returns a true result. The Boolean block 179 determines the dither active signal 172.

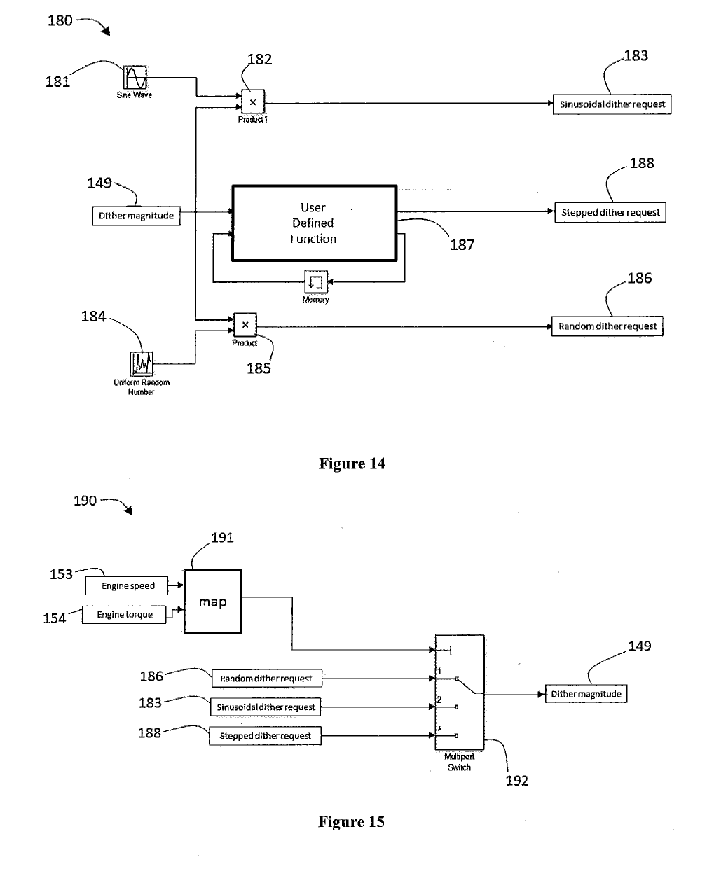

Referring now to FIG. 14, in one embodiment, the dither command generator sub-module 142 is configured to include a dither profile sub-module 180. The dither profile sub-module 180 is configured to generate a number of high frequency signals having the dither magnitude signal 149 as the amplitude. In some embodiments, the dither profile sub-module 180 includes a sine wave generator block 181 that is configured to provide a high frequency sine wave signal that is passed to a first multiplication block 182 where the sine wave signal is multiplied by the dither magnitude signal 149. The first multiplication block 182 passes a sinusoidal dither request signal 183 to the dither command generator sub-module 142. In some embodiments, the dither profile sub-module 180 includes a random number generator 184 that is configured to provide a high frequency random value signal that is passed to a second multiplication block 185 where the random value signal is multiplied by the dither magnitude signal 149. The second multiplication block 185 passes a random dither request signal 186 to the dither generator sub-module 142. In some embodiments, the dither profile sub-module 180 includes a user defined function block 187 configured to provide a high frequency signal having an amplitude equal to the dither magnitude signal 149. In some embodiments, the user defined function block 187 is configured to provide a high frequency step signal that oscillates from a low value, zero value, and high value. The user defined function block 187 passes a stepped dither request signal 188 to the dither command generator sub-module 142. In some embodiments, the frequency of the sinusoidal dither request signal 183, the random dither request signal 186, and the stepped dither request signal 188 is set by a calibrateable variable (not shown) that is read from memory. The frequency range is in the range of the loop execution rate of the software module and is adjusted based on desired operating condition and feel of the transmission.

Turning now to FIG. 15, in one embodiment, the dither command generator sub-module 142 includes a dither profile selector sub-module 190. The dither profile selector sub-modules 190 includes a calibratable look-up table 191 configured to receive the engine speed signal 153 and the engine torque signal 154. The calibratable look-up table 191 contains values corresponding to a desired dither profile based at least in part on the engine speed signal 153 and the engine torque signal 154. The calibratable look-up table 191 passes a signal to a switch block 192. The switch block 192 selects between the sinusoidal dither request signal 183, the random dither request signal 186, and the stepped dither request signal 188 based at least in part on the signal received from the calibratable look-up table 191. The switch block 192 passes the dither request signal 193 to the dither command generator sub-module 142 for use by other sub-modules.

Referring now to FIGS. 16 and 17, in some embodiments, the dither criteria sub-module 200 is configured to determine the dither enable variable 150. In some embodiments, the dither enable variable 150 is optionally used in place of the dither active signal 172. The dither criteria sub-module 200 receives an enable calibration variable 201, a current CVT ratio setpoint 202, the input traction ring stress threshold calibration variable 151, output traction ring stress threshold calibration variable 152, an input ring contact stress 203, an output ring contact stress 204. In some embodiments, the enable calibration variable 201 is a parameter stored in memory to indicate that the dither control methods executed by the dither control sub-module 140 are enabled for transmissions equipped with the transmission control module 104. In some embodiments, the input ring contact stress 203 and the output ring contact stress 204 are parameters calculated by other sub-modules of the transmission control module 104 and typically functions of the input torque to the CVT.

Referring to FIG. 17, in some embodiments, the dither criteria sub-module 200 applies a Kalman filter 205 to the current CVT Ratio Setpoint 202 to determine a CVT Ratio Delta 206. A Kalman filter has both filtering and predictive estimation properties. For the dither criteria sub-module 200, the Kalman filter 205 provides an indication of the rate of change of the current CVT Ratio setpoint 202 with the CVT Ratio Delta 206. A Kalman filter is ideally suited to an application where noise removal and fast response to disturbances are equally important. The CVT Ratio Delta 206 is passed to a low pass filter 207 to form a filtered CVT Ratio Delta 208. The filtered CVT Ratio Delta 208 is passed to a CVT Ratio Stability sub-module 209 where an algorithm is applied to determine if the CVT ratio setpoint 202 is changing at a rate outside of a calibrated threshold. If the CVT ratio setpoint is changing at a rate above the calibrated threshold, dither is not enabled. In some embodiments, the CVT Ratio Stability sub-module 208 is a simple hysteresis function that requires that CVT ratio setpoint point rate of change to be below a threshold for a specified length of time before dither entry, and above the same threshold for the same time before dither exit. The CVT Ratio Stability sub-module 209 returns a CVT Ratio Stable Enable variable 210 that is indicates that dither of the speed ratio should be applied or not.

Referring still to FIG. 17, the dither criteria sub-module 200 includes a contact stress hysteresis sub-module 211 adapted to determine if dither is active based on the input traction ring stress threshold calibration variable 151, the output traction ring stress threshold calibration variable 152, the input ring contact stress 203, and the output ring contact stress 204. In some embodiments, the contact stress hysteresis sub-module 211 is a simple hysteresis function that requires the input ring contact stress 203 and the output ring contact stress 204 to be above a threshold for a specified length of time before enabling dither. In some embodiments, the contact stress hysteresis sub-module 211 is a simple hysteresis function that requires the input ring contact stress 203 and the output ring contact stress 204 to be below a threshold for a specified length of time before disenabling dither. In other embodiments, the contact stress hysteresis sub-module 211 implements a one dimensional look-up table based on speed ratio. The contact stress hysteresis sub-module 211 receives the greater than or equal to between the input ring contact stress 203 and the input ring stress threshold calibration variable 151 or the greater than or equal to between the output ring contact stress 204 and the output ring contact stress threshold calibration variable 152. The dither criteria sub-module 200 evaluates the output of the contact stress hysteresis sub-module 211, the CVT Ratio Stability sub-module 209 and the enable calibration variable 201. If the output of the contact stress hysteresis sub-module 211, the CVT Ratio Stability sub-module 209 and the enable calibration variable 201 are all true values, the dither enable variable 150 is true and dither control is active.

Referring now to FIGS. 18 and 19, in some embodiments, the dither command generator sub-module 142 includes a dither profile selector sub-module 220 and a dither profile sub-module 223 as options to the dither profile selector sub-module 190 and the dither profile sub-module 180, respectively.

In some embodiments, the dither profile selector sub-module 220 includes a dither mode look-up table 221 configured to receive the engine speed 153 and the engine torque 154. The dither mode look-up table 221 is a calibrateable table containing a dither mode 222 based on the engine speed 153 and the engine torque 154. In some embodiments, the dither mode 222 is a signal indicative of a desired dither profile such as a sinusoidal pattern, a stepped pattern, or a random pattern. The dither mode 222 is passed to the dither profile sub-module 223. In some embodiments, the dither profile sub-module 223 includes a user defined function 224 configured to receive the dither mode 222, the dither magnitude 149, and a dither frequency 225. In some embodiments, the dither frequency 225 is a calibrateable variable stored in memory. The dither frequency 225 is optionally stored as a look-up table based on a number of operating conditions such as engine speed, engine torque, vehicle speed, and CVP speed ratio, among others. In some embodiments, the user defined function is a programmable algorithm configured to generate the dither request 155. It should be appreciated that the user defined function is optionally programmed to provide a dither request 155 as a sinusoidal, stepped, random, or other user defined profile to suit the designer's choice. The dither request signal 155 is applied to the commanded speed ratio signal 144 to form a final ratio command signal 156.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the embodiments with which that terminology is associated.

While preferred embodiments of the present embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein could be employed in practice. It is intended that the following claims define the scope of the preferred embodiments and that methods and structures within the scope of these claims and their equivalents be covered thereby.

What is claimed is:

1. A computer-implemented system for a vehicle having an engine coupled to a continuously variable transmission having a ball-planetary variator (CVP), the computer-implemented system comprising:
a digital processing device comprising an operating system configured to perform executable instructions and a memory device;
a computer program including instructions executable by the digital processing device comprising a software module configured to manage operating conditions of the CVP;
a plurality of data signals comprising:
a CVP speed ratio,
an input traction ring torque, and
an engine speed,
wherein the software module is configured to execute a dither control sub-module, wherein the dither control sub-module includes a look-up table configured to store values of a contact patch size based at least in part on the CVP input torque.

2. The computer-implemented system of claim 1, wherein the dither control sub-module further comprises a dither magnitude sub-module and a dither command generator sub-module.

3. The computer-implemented system of claim 2, wherein the dither control sub-module is adapted to receive a first calibration variable indicative of ball diameter, a second calibration variable indicative of a gamma angle range, and a third calibration variable indicative of a ratio range of the CVP.

4. The computer-implemented system of claim 3, wherein the dither magnitude sub-module is configured to determine a dither magnitude signal based at least in part on the input traction ring torque and the CVP speed ratio, the first calibration variable, the second calibration variable, and the third calibration variable.

5. The computer-implemented system of claim 4, wherein the dither command generator sub-module further comprises a dither activation sub-module.

6. The computer-implemented system of claim 5, wherein the dither activation sub-module is configured to receive an input traction ring stress threshold calibration variable, and an output traction ring stress threshold calibration variable and to determine a dither active signal based at least in part on the input traction ring torque, the input traction ring stress threshold calibration variable and the output traction ring stress threshold calibration variable and

7. The computer-implemented system of claim 5, wherein the dither command generator sub-module further comprises a dither profile sub-module configured to generate a plurality of high frequency signals adapted to apply the dither magnitude signal, wherein the plurality of high frequency signals includes a sinusoidal frequency, a stepped frequency, and a random frequency.

8. The computer-implemented system of claim 7, wherein the plurality of high frequency signals includes a user defined profile.

9. The computer-implemented system of claim 7, wherein the dither command generator sub-module further comprises a dither profile selector sub-module including a calibratable look-up table configured to store values corresponding to a desired dither profile based at least in part on the engine speed and an engine torque.

10. The computer-implemented system of claim 2, wherein the dither control sub-module further comprises a dither criteria sub-module adapted to determine an enable condition for a dither enable command including a CVT ratio stability sub-module and a contact stress hysteresis sub-module,
wherein the CVT ratio stability sub-module evaluates a rate of change of the CVT speed ratio,
wherein the contact stress hysteresis sub-module evaluates an amount of time during operation at the input traction ring torque, and
wherein the dither criteria sub-module commands the dither enable command based on the rate of change of the CVT speed ratio and the amount of time during operation at the input traction ring torque.

11. A method for preventing slip in a continuously variable transmission having a ball-planetary variator (CVP), the method comprising the steps of:
operating a continuously variable planetary having a plurality of tiltable balls in contact with a first traction ring assembly and a second traction ring assembly wherein a speed ratio between the first traction ring assembly and the second traction ring assembly corresponds to a title angle of the balls;
receiving a plurality of signals from sensors equipped on the CVP, the signals indicative of a CVP speed ratio, a CVP input traction ring torque, and an engine speed;
determining a contact patch size, wherein the contact patch is formed between contacting components of the CVP;
determining a contact patch location, wherein the contact patch location is based at feast in part on the dimensions of the CVP and the CVP speed ratio; and
determining a dither magnitude signal based at least in part on the plurality of signals, the contact patch size and the contact patch location.

12. The method of claim 11, wherein determining the contact patch size is based at least in part on a ball diameter and the CVP input traction ring torque.

13. The method of claim 12, wherein determining the dither magnitude signal is based at least in part on the CVP input traction ring torque.

14. The method of claim 13, further comprising the steps of:
determining an operating mode of a vehicle;
determining a dither profile based at least upon the operating mode of the vehicle; and
applying the dither profile to a commanded speed ratio.
